(19) United States
(12) Patent Application Publication
(10) Pub. No.: US 2025/0335105 A1
(43) Pub. Date: Oct. 30, 2025

(54) METHOD AND APPARATUS FOR IMPROVING RAID CONTROLLER PERFORMANCE WITH CACHE ENHANCEMENTS

(71) Applicant: Dell Products L.P., Round Rock, TX (US)

(72) Inventors: Kanaka Charyulu, Bangalore (IN); Vinod Gr, Bangalore (IN); Manish Patil, Bangalore (IN); Dhananjaya Lingaraju, Bangalore (IN)

(73) Assignee: Dell Products L.P., Round Rock, TX (US)

(21) Appl. No.: 18/647,244

(22) Filed: Apr. 26, 2024

(51) Int. Cl. G06F 3/06; G06F 12/123

(52) U.S. Cl. CPC G06F 3/0619; G06F 3/0656; G06F 3/0689; G06F 12/123

(57) ABSTRACT

A method, comprising: identifying, by a processing circuitry of a storage device controller, a plurality of memory portions of a volatile memory of the storage device controller; generating one or more data structures that map each of the plurality of memory portions to a different one of a plurality of logical drives; using each of the plurality of memory portions to exclusively cache data for the one of the plurality of logical drives that is mapped to that memory portion, such that none of the memory portions is used to cache data for any of the plurality of logical drives other than the logical drive that is mapped to that memory portion; detecting a failure of a given one of the plurality of logical drives; identifying the one of the plurality of memory portions that is mapped to the given logical drive; and blocking the identified memory portion.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method is provided, comprising: identifying, by a processing circuitry of a storage device controller, a plurality of memory portions of a volatile memory of the storage device controller; generating, by the processing circuitry, one or more data structures that map each of the plurality of memory portions to a different one of a plurality of logical drives; using each of the plurality of memory portions to exclusively cache data for the one of the plurality of logical drives that is mapped to that memory portion, such that none of the memory portions is used to cache data for any of the plurality of logical drives other than the logical drive that is mapped to that memory portion; detecting, by the processing circuitry, a failure of a given one of the plurality of logical drives; identifying the one of the plurality of memory portions that is mapped to the given logical drive; and blocking the identified memory portion while allowing the remaining ones of the plurality of memory portions to be used for the caching of data, so as to permit the plurality of logical drives, other than the given logical drive, to operate in write-back mode while the given logical drive is unavailable.

According to aspects of the disclosure, a storage device controller is provided, comprising: a volatile memory; and a processing circuitry that is operatively coupled to the volatile memory, the processing circuitry being configured to perform the operations of: identifying a plurality of memory portions of the volatile memory; generating one or more data structures that map each of the plurality of memory portions to a different one of a plurality of logical drives; using each of the plurality of memory portions to exclusively cache data for the one of the plurality of logical drives that is mapped to that memory portion, such that none of the memory portions is used to cache data for any of the plurality of logical drives other than the logical drive that is mapped to that memory portion; detecting, by the processing circuitry, a failure of a given one of the plurality of logical drives; identifying the one of the plurality of memory portions that is mapped to the given logical drive; and blocking the identified memory portion while allowing the remaining ones of the plurality of memory portions to be used for the caching of data, so as to permit the plurality of logical drives, other than the given logical drive, to operate in write-back mode while the given logical drive is unavailable.

According to aspects of the disclosure, a non-transitory computer-readable storage medium storing one or more processor-executable instructions, which, when executed by a processing circuitry of a storage device controller, cause the processing circuitry to perform the operations of: identifying, by a processing circuitry of a storage device controller, a plurality of memory portions of a volatile memory of the storage device controller; generating, by the processing circuitry, one or more data structures that map each of the plurality of memory portions to a different one of a plurality of logical drives; using each of the plurality of memory portions to exclusively cache data for the one of the plurality of logical drives that is mapped to that memory portion, such that none of the memory portions is used to cache data for any of the plurality of logical drives other than the logical drive that is mapped to that memory portion; detecting, by the processing circuitry, a failure of a given one of the plurality of logical drives; identifying the one of the plurality of memory portions that is mapped to the given logical drive; and blocking the identified memory portion while allowing the remaining ones of the plurality of memory portions to be used for the caching of data, so as to permit the plurality of logical drives, other than the given logical drive, to operate in write-back mode while the given logical drive is unavailable.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a computing system, according to aspects of the disclosure;

FIG. 2A is a diagram of an example of a storage device controller, according to aspects of the disclosure;

FIG. 2B is a diagram of an example of a data structure, according to aspects of the disclosure;

FIG. 3 is a flowchart of an example of a process, according to aspects of the disclosure, according to aspects of the disclosure;

FIG. 4 is a flowchart of an example of a process, according to aspects of the disclosure;

FIG. 5 is a flowchart of an example of a process, according to aspects of the disclosure; and

FIG. 6 is a flowchart of an example of a process, according to aspects of the disclosure, according to aspects of the disclosure.

### DETAILED DESCRIPTION

A system and method are disclosed for optimizing cache memory utilization in Redundant Array of Independent Disks (RAID) controllers. The system and method may be used to improve the operation of RAID controllers that are used in distributed storage systems as well as RAID controllers that are used in other types of computing devices, such as personal computers. Although the system and method are presented in the context of RAID, it will be understood that the ideas presented throughout the disclosure apply to any suitable type of storage controller.

The system and method enhances input/output (I/O) operations, accelerates recovery from drive failures, and ensures data integrity during power loss events. By intelligently managing cache memory, the system improves overall performance and reliability of RAID systems.

RAID controllers are conventionally equipped with cache memory to enhance input/output (I/O) operations. This cache memory not only optimizes I/O operations but also facilitates faster recovery in the event of drive failures by optimizing rebuild functionality. Moreover, the cache is utilized for storing critical logs such as debug information, which proves invaluable during controller or system crashes. The size of the controller cache memory typically ranges from 2 GB to 8 GB, with higher-end controllers featuring larger cache memories to accommodate faster media and larger volumes.

A RAID controller may operate a logical drive in a write-back (WB) mode or a write-through (WT) mode. When a logical drive is operated in WT mode, data associated with write requests is written directly to the underlying physical storage devices before the write requests are acknowledged. When the logical drive is operated in WB mode, data associated with write requests is stored in cache and subsequently stored in the underlying physical storage devices. When the logical drive is operated in WB mode, the write requests are acknowledged upon the storage of their associated data in cache. In contrast to WT mode, the data associated with write requests may be copied to the underlying physical storage devices after the write requests are acknowledged.

While operating a logical drive in WB mode enhances performance, it poses a risk of data loss in the event of a power loss since uncommitted data residing in the cache may not be transferred to physical disks. To mitigate this risk, an onboard battery is provided to provide a power backup to the volatile memory that is used to implement the cache. On the other hand, operating the logical drive in WT mode offers protection against data loss but at the expense of slower performance due to the necessity of committing writes to physical drives before acknowledging the writes and processing subsequent write requests.

Furthermore, the cache memory is commonly shared across multiple logical drives of the controller. However, this design exhibits drawbacks, particularly when a logical drive (or its underlying disk group) becomes unavailable due to a failure. In such scenarios, the entirety of cache memory would be locked (or fenced off) to prevent corruption or loss of data that is stored in the cache memory, which has not yet been copied to the logical drive. When the logical drive becomes available again, the cache memory may be unblocked and cached data associated with the logical drive may be committed.

A disadvantage of the above approach is that all logical drives of the RAID controller which are currently using the cache memory have to be switched to WT mode. Since the cache memory is shared among all logical drives, blocking (or fencing off) the entire cache memory prevents the other logical drives, which remain operational, from using the cache memory, which in turn requires that they be switched to WT mode. Furthermore, when the cache memory is disabled, not only do the remainder of logical drives fall back to WT mode, but background RAID operations the controller supports, such as Reconfiguration (Raid level migration, Online Capacity expansion—which are cache intensive operations) are also disabled, causing a significant impedance in the functionality offered by the RAID controller.

To address these limitations, an improved method for caching data is disclosed. The improved method, instead of permitting the entire cache memory to be universally shared among all logical drives of a RAID controller, partitions the cache memory into smaller logical units of finite size and dedicates each of the smaller logical units for use by a single one of the logical drives. Each logical unit may be structured as a circular buffer or a similar data structure to uphold eviction order. Additionally, an extra hash map can be incorporated to track evicted data from the cache memory, expediting lookup operations. This hash map is advantageous for prefetching READs promptly and retaining references to recently modified data for WRITE requests. Consequently, this optimization accelerates both READ and WRITE operations concerning data previously evicted from the cache memory. Furthermore, this arrangement imposes limits on cache memory utilization by volumes, ensuring adherence to allocated sizes.

According to the improved method, when a logical drive experiences a failure, uncommitted data for the failed logical drive is confined solely to the cache memory region that is dedicated for use by the failed logical drive, rather than the entire cache memory. As a result of this arrangement, only the cache memory region that is dedicated to the failed logical drive may be blocked (or fenced off), while allowing the remaining logical drives to continue to operate in WB mode and use their respective dedicated cache memory regions.

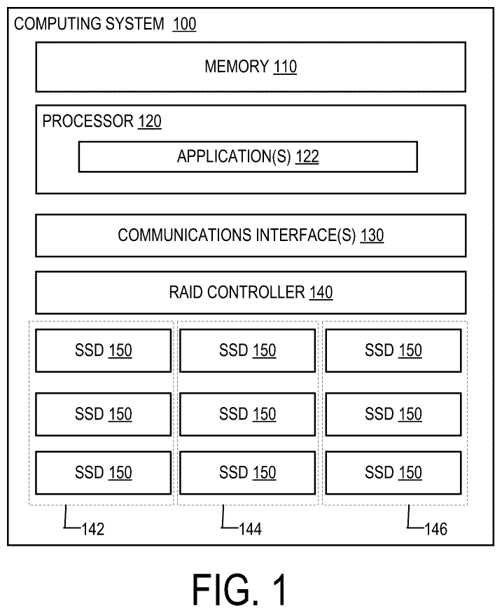

FIG. 1 is a diagram of an example of a computing system 100, according to aspects of the disclosure. As illustrated, the computing system may include a memory 110, a processor 120, a communications interface 130, a RAID controller 140, and a plurality of storage devices 150. The memory 110 may include one or more of a random-access memory (RAM), a dynamic random memory (DRAM), a flash memory, a hard drive (HD), a solid-state drive (SSD), a network-accessible storage (NAS), and or any other suitable type of memory device. The processor 120 may include any of one or more general-purpose processors (e.g., x86 processors, RISC processors, ARM-based processors, etc.), one or more Field Programmable Gate Arrays (FPGAs), one or more application-specific circuits (ASICs), and/or any other suitable type of processing circuitry. The communications interface 130 may include any suitable type of communications interface, such as one or more Ethernet adapters, one or more InfiniBand adapters, one or more Fibre Channel adapters, one or more Wi-Fi adapters (e.g., 802.1414 adapters), and one or more Long-Term Evolution (LTE) adapters, for example. According to the present example, each storage device 150 is a solid-state drive. However, alternative implementations are possible in which any of the storage devices 150 is a hard disk and/or any other suitable type of storage device.

According to the present example, storage devices 150 are integrated with computing system 100. However, alternative implementations are possible in which storage devices 150 are provided separately from computing system 100. In such implementations, the storage devices 150 may be provided in a separate disk array enclosure (DAE) or in a different computing device. It will be understood that the present disclosure is not limited to any specific method for providing storage devices 150.

According to the present example, controller 140 is integrated with the computing system 100 and connected to the processor 120 via a peripheral bus (e.g., a peripheral component interconnect express (PCIe) bus). However, alternative implementations are possible in which RAID controller is provided separately from the storage device. In such implementations, controller 140 may be provided in a separate DAE (or a separate computing device) together with the storage devices 150. When the controller 140 is provided in a separate DAE (or a separate computing device) controller 140 may be connected to processor 120 via a communications network (e.g., an Ethernet network, an InfiniBand network, a Fibre Channel network, etc.).

In some implementations, computing system 100 may be a storage processor that is part of a distributed storage system. However, it will be understood that the present disclosure is not limited to any specific implementation of the computing system 100.

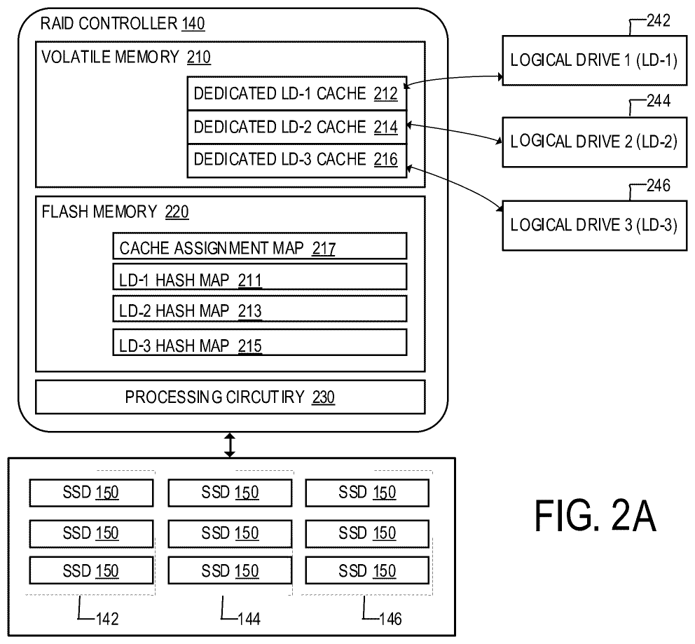

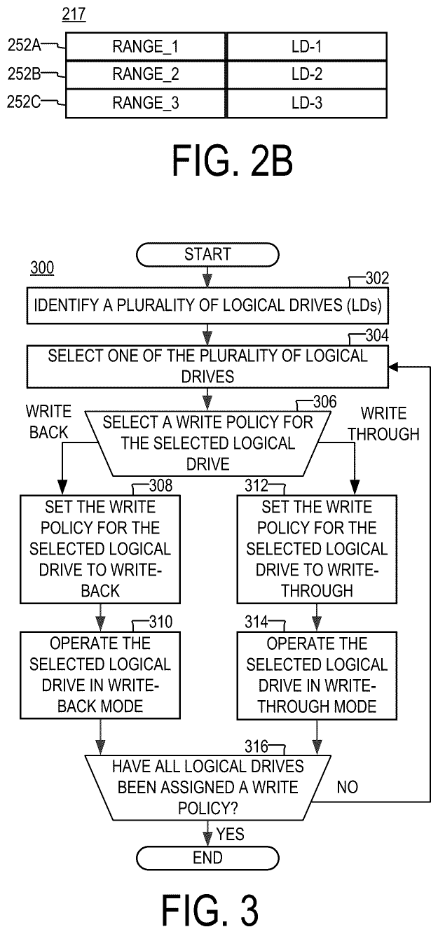

The storage devices 150 may be arranged into RAID groups 142, 144, and 146. Controller 140 may be configured to implement logical drives 242, 244, and 246 (shown in FIG. 2A). RAID group 142 may be mapped to logical drive 242, RAID group 144 may be mapped to logical drive 244, and RAID group 146 may be mapped to logical drive 246. The controller 140 may perform: (i) physical-to-logical address mapping between RAID group 142 and logical drive 242, (ii) physical-to-logical address mapping between RAID group 144 and logical drive 244, (iii) physical-to-logical address mapping between RAID group 146 and logical drive 246. Each of the logical drives 242, 244, and 246 (shown in FIG. 2A) may be a separate data volume and/or any other suitable type of storage unit.

In operation, controller 140 may receive write requests from processor 120 and execute each of the write requests by writing data to one of the logical drives 242, 244, and 246 that is identified in the write request. As used herein, the phrase “writing data to a given one of the logical drives 242, 244, and 246” means “writing data to one of the RAID groups 142, 144, and 146 that is used to implement the given logical drive”. Although each of the RAID groups 142-146 includes only three storage devices, alternative implementations are possible in which any of the RAID groups 142-146 includes a greater number of storage devices. The write requests that are executed by controller 140 may be generated by any of the applications 122, which are executed by the processor 120. In other words, controller 140 may be configured to execute write requests that originate from the application layer of computing system 100.

In operation, controller 140 may receive read requests from processor 120 and execute each of the read requests by retrieving data from one of the logical drives 242, 244, and 246 that is identified in the read request. As used herein, the phrase “retrieving data from a given one of the logical drives 242, 244, and 246” means “retrieving the data from one of the RAID groups 142, 144, and 146 that is used to implement the given logical drive”. The read requests that are executed by controller 140 may be generated by any of applications 122, which are executed by the processor 120. In other words, controller 140 may be configured to execute read requests that originate from the application layer of computing system 100.

FIG. 2A shows the controller 140 in further detail, in accordance with one possible implementation. According to the example of FIG. 2A, controller 140 includes a volatile memory 210, a flash memory 220, and a processing circuitry 230. The processing circuitry 230 may include any suitable type of digital logic, such as an ARM processor, a MIPS processor, an application-specific circuit, etc., According to the present example, the memory 210 is dynamic random-access memory (DRAM). However, it will be understood that memory 210 may be implanted by using any suitable type of volatile memory, such as static random-access memory (SRAM) or synchronous dynamic random-access memory (SDRAM). Although, in the present example, memory 220 is flash memory, alternative implementations are possible in which memory 220 is another type of non-volatile memory, such as electrically erasable programmable read-only memory (EEPROM).

Memory 210 may be used to implement a cache for logical drives 242, 244, and 246. Memory 210 may include portions 212, 214, and 216. Portion 212 may be used to exclusively cache data for logical drive 242—e.g., data that is required to be written to logical drive 242 (and/or associated metadata) or data that is read from logical drive 242 (and/or associated metadata). Portion 212 is not used to cache data for any other logical drive. Portion 214 may be used to exclusively cache data for logical drive 244—e.g., data that is required to be written to logical drive 244 (and/or associated metadata) or data that is read from logical drive 244 (and/or associated metadata). Portion 214 is not used to cache data for any other logical drive. Portion 216 may be used to exclusively cache data for logical drive 246—e.g., data that is required to be written to logical drive 246 (and/or associated metadata) or data that is read from logical drive 246 (and/or associated metadata). Portion 216 is not used to cache data for any other logical drive. In some implementations, each of portions 212, 214, and 216 may be implemented as a circular memory buffer (i.e., ring buffer).

In some implementations, the size of each of portions 212, 214, and 216 may depend on the size of the logical drive that corresponds to the portion. Specifically, the size of any of portions 212, 214, or 216 may be determined in accordance with the equation of:

$$dramPortionSize = logicalDriveSize \times ( \frac{totalSpaceAvailableForCaching}{combinedSizeOfAllLogicalDrives} ) \qquad ( 1 )$$

where dramPortionSize is the size of the portion of memory 210 that is dedicated to caching data exclusively for a given logical drive (e.g., one of logical drives 242, 244, and 246); logicalDriveSize is the size of the given logical drive; totalSpaceAvailableForCaching is the size of the portion of volatile memory 210 that is desired to be used for the caching of data for logical drives that are managed by the controller 140 (e.g., the logical drives 242, 244, and 246); and combinedSizeofAllLogicalDrives is the combined size of the logical drives that are managed by the controller 140 (e.g., the combined size of logical drives, 242, 244, and 246).

Memory 220 may be configured to store a data structure 217. As illustrated in FIG. 2B, data structure 217 may include a plurality of entries 252. Each entry 252 may map a different contiguous or non-contiguous range of addresses in memory 210 to a corresponding identifier of one of the logical drives that are managed by controller 140. Entry 252A may map a first range of addresses (contiguous or non-contiguous) to the logical drive 242. Specifically, entry 252A may include an indication of the first range of addresses and an identifier corresponding to logical drive 242. Entry 252B may map a second range of addresses (contiguous or non-contiguous) to the logical drive 244. Specifically, entry 252B may include an indication of the second range of addresses and an identifier corresponding to logical drive 244. Entry 252C may map a third range of addresses (contiguous or non-contiguous) to the logical drive 246. Specifically, entry 252C may include an indication of the third range of addresses and an identifier corresponding to logical drive 246.

Memory 210 may also be configured to store the data structures 211, 213, and 215. Data structure 211 may identify a plurality of cache slots that are available in portion 212. Of these cache slots, data structure 211 may identify the least recently used cache slot in portion 212. Data structure 211 may be used to allocate cache slots in portion 212. In one example, data structure 211 may be implemented as a hash map. However, the present disclosure is not limited to any specific implementation of data structure 211. In some implementations, data structure 211 may identify a plurality of cache slots that are available in memory portion 212. Each of the cache slots may be identified by using a respective memory address (e.g., row, column, bank) that belongs in memory portion 212. The term cache slot refers to a single memory address (or block) or a group of memory addresses (or blocks) that are treated as a single unit for the purposes of caching.

Data structure 213 may identify a plurality of cache slots that are available in portion 214. Of these cache slots, data structure 213 may identify the least recently used cache slot in portion 214. Data structure 213 may be used to allocate cache slots in portion 214. In one example, data structure 213 may be implemented as a hash map. However, the present disclosure is not limited to any specific implementation of data structure 213. In some implementations, data structure 213 may identify a plurality of cache slots that are available in memory portion 214. Each of the cache slots may be identified by using a respective memory address (e.g., row, column, bank) that belongs in memory portion 214.

Data structure 215 may identify a plurality of cache slots that are available in portion 216. Of these cache slots, data structure 215 may identify the least recently used cache slot in portion 216. Data structure 215 may be used to allocate cache slots in portion 216. In one example, data structure 215 may be implemented as a hash map. However, the present disclosure is not limited to any specific implementation of data structure 215. In some implementations, data structure 215 may identify a plurality of cache slots that are available in memory portion 216. Each of the cache slots may be identified by using a respective memory address (e.g., row, column, bank) that belongs in memory portion 216.

As noted above, data structure 217 is used to define each of the memory caches that are dedicated to logical drives 242, 244, and 246. However, in some implementations, data structure 217 may be omitted and only data structures 211, 213, and 215 may be used instead to define the dedicated memory caches. Although, in the present example, data structure 217 is stored in memory 220 alternative implementations are possible in which data structure 217 is stored in memory 210 or elsewhere.

As noted above, data structures 211, 213, and 215 may be used to identify individual cache slots in portions 212, 214, and 216, respectively. Moreover, each of data structures 211, 213, and 215 may identify the age of the cache slots in that data structure's respective memory portion. This information may be used to identify the least recently used cache slot in each of portions 212, 214, and 216. According to the present example, a least recently used (LRU) algorithm is used to allocate cache slots in any of memory portions 212, 214, and 216. However, the present disclosure is not limited to using any specific allocation algorithm.

Although data structures 217, 211, 213, and 215 are stored in memory 220, alternative implementations are possible in which data structures are stored in memory 210 or elsewhere. Although data structures 211, 213, and 215 are depicted as separate entities, alternative implementations are possible in which two or more of data structures 211, 213, and 215 are integrated together in the same data structure. Additionally or alternatively, two or more of data structures 211, 213, and 215 may be integrated with data structure 217 in the same data structure. Stated succinctly, the present disclosure is not limited to any specific implementation of data structures 217, 211, 213, and 215. The term “data structure” as used throughout the disclosure means “a contiguous or non-contiguous region in one or more memory modules that is used to store data”. The use of the term “data structure” does not presuppose the use of specific metadata or a specific set of one or more pointers for accessing the data structure.

FIG. 3 is a flowchart of an example of process 300, according to aspects of the disclosure. At step 302, controller 140 identifies a plurality of logical drives. According to the present example, controller 140 identifies logical drives 242, 244, and 246. At step 304, controller 140 selects one of the plurality of logical drives that have not been selected during a previous iteration of step 304.

At step 306, controller 140 selects a write policy for the selected logical drive. According to the present example, controller 140 selects one of a write-back policy and a write-through policy. If write-back is selected as the write policy, process 300 proceeds to step 308. Otherwise, if write-through is selected as the write policy, process 300 proceeds to step 312.

In one example, the selection may made based on a configuration setting that is associated with the selected storage device (or all of the plurality of storage devices). The configuration setting may be stored in memory 220 or elsewhere. If the configuration setting is set to a first value (e.g., ‘1’), controller 140 may select write-back as the write policy for the selected logical drive. On the other hand, if the configuration setting is set to a second value (e.g., ‘0’), controller 140 may select write-through as the write policy for the selected logical drive.

As another example, the selection may be based on the current status of the memory portion (i.e., one of memory portions 212, 216, and 214) that is dedicated to caching data for the selected logical drive. For example, if the memory portion is currently blocked or unavailable, or if no memory portion has been allocated for caching data for the selected logical drive, controller 140 may select write-through as the write policy for the selected logical drive. Otherwise, controller 140 may select write-back as the write policy for the selected logical drive.

At step 308, write-back is set as the write policy for the selected logical drive. Specifically, controller 140 may set a configuration setting (in memory 210 or 220) that is associated with the selected logical drive to a value that indicates that the selected logical drive should be operated in WB mode.

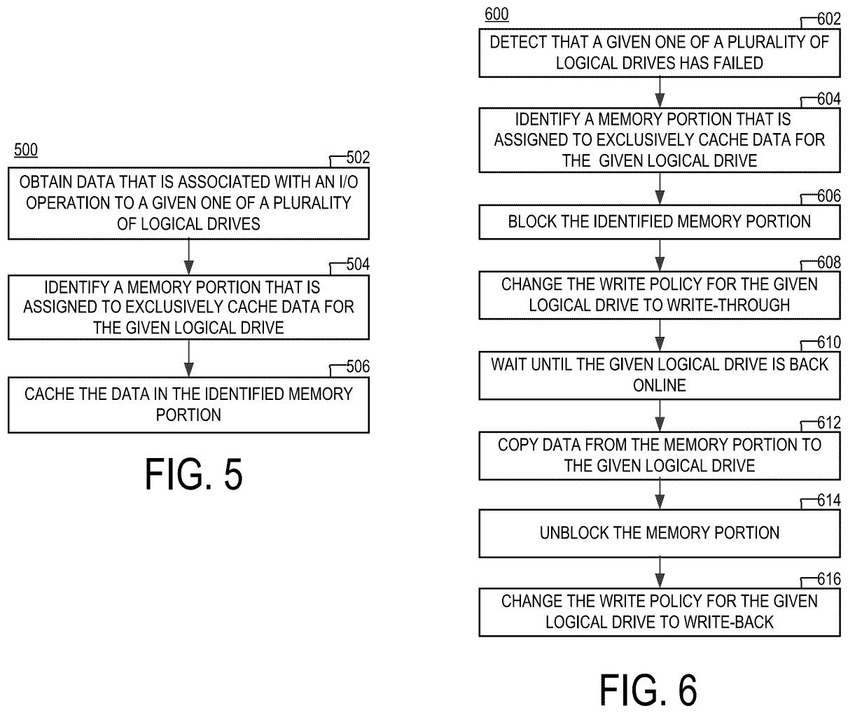

At step 310, controller 140 begins operating the storage device in WB mode. In one example, operating the selected storage device in WB mode may include executing processes 500-600, which are discussed further below with respect to FIGS. 5-6.

At step 312, write-through is set as the write policy for the selected logical drive. Specifically, controller 140 may set a configuration setting (in memory 210 or 220) that is associated with the selected logical to a value that indicates that the selected logical drive should be operated in WT mode.

At step 314, controller 140 begins operating the storage device in WT mode.

At step 316, controller 140 determines if all of the logical drives (identified at step 302) have been assigned a write policy. If not all of the logical drives (identified at step 302) have not been selected during an iteration of step 304, process 300 returns to step 304 and another one of the logical drives is selected. Otherwise, if all of the logical drives (identified at step 302) have already been selected during earlier iterations of step 304, process 300 ends.

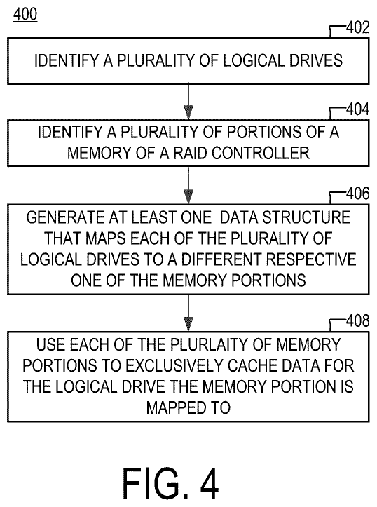

FIG. 4 is a flowchart of an example of a process 400, according to aspects of the disclosure.

At step 402, controller 140 identifies a plurality of logical drives. According to the present example, logical drives 242, 244, and 246 are identified.

At step 404, controller 140 identifies a plurality of memory portions in memory 210. The memory portions may be contiguous or non-contiguous. Identifying any of the memory portions may include selecting a plurality of memory addresses (or a range of memory addresses) in memory 210 that would be used to cache data for one of the logical drives. In some implementations, the size of each of the identified memory portions may be based on the size of a different respective one of the logical drives, whose data would be cached in that memory portion. In some implementations, the size of each of the memory portions may be determined in accordance with equation 1, which is discussed above with respect to FIG. 2. According to the present example, memory portions 212, 214, and 216 are identified.

At step 406, controller 140 generates at least one data structure that maps each of the plurality of logical drives (identified at step 402) to a different one of the plurality of memory portions (identified at step 404). According to the present example, data structure 217 and data structures 211, 213, and 215 are generated. However, alternative implementations are possible in which only data structure 217 is generated.

At step 408, each of the memory portions (identified at step 404) is used to exclusively cache data for the logical drive that the memory portion is mapped to by the data structures (generated at step 406). As used throughout the disclosure, the phrase “a memory portion A is used to exclusively cache data for logical drive B” shall mean that memory portion A is used to store data that is read or written to logical drive B, but not to any other logical drive.

FIG. 5 is a flowchart of an example of a process 500, according to aspects of the disclosure.

At step 502, controller 140 obtains data that is associated with an input-output (I/O) operation to a given one of a plurality of logical drives. According to the present example, the I/O operation is associated with one of the logical drives 242, 244, and 246. The obtained data is either data that is required to be written to the logical drive or data that is retrieved from the logical drive.

At step 504, controller 140 identifies a memory portion that is assigned to exclusively cache data for the given logical drive According to the present example, one of memory portions 212, 214, and 216 is identified. According to one, the memory portion is identified by performing a search of data structure 217. The search may be performed based on an identifier of the given logical drive. The search may yield an identifier of the memory portion that is mapped to the given storage device.

At step 506, the data (obtained at step 502) is cached in the memory portion (identified at step 504). In one example, caching the data may include selecting a cache slice in the memory portion (identified at step 504) and storing the data in the selected cache. In one example, the cache slice may be identified by using a data structure, such as one of data structures 211, 213, and 215, which identifies the least recently used cache slice in the memory portion (identified at step 504). According to the present example, the selected cache slice is the least recently used cache slice in the memory portion (identified at step 504). However, the present disclosure is not limited thereto.

In some implementations, when the I/O operation (discussed with respect to step 502) is a write operation, and after step 506 is completed, controller 140 may notify processor 120 (shown in FIG. 1) that the write operation has been completed. The notification may be made before the data is copied from the memory portion (identified at step 504) into the RAID group of storage devices that is underlying the given logical drive.

FIG. 6 is a flowchart of an example of a process 600, according to aspects of the disclosure.

At step 602, controller 140 detects that a given one of a plurality of logical drives has failed. According to the present example, the plurality of logical drives includes logical drives 242, 244, and 246. According to the present example, logical drive 242 is the failed drive. According to the present example, a logical drive is considered to have failed if it has generated an error or if it is otherwise unavailable to store data (e.g., unavailable to store data at all or unavailable to store data safely). Under the nomenclature of the present disclosure, a logical drive is considered offline when: (i) the logical drive is unavailable to store data at all, (ii) the logical drive has generated an error (the error may be generated by the logical drive or the underlying RAID group), or (iii) when the logical drive is unavailable to store data safely. Under the nomenclature of the present disclosure, a logical drive is considered to be back online when the problem that caused the logical drive to go offline is rectified.

At step 604, controller 140 identifies a memory portion that is assigned to exclusively cache data for the given logical drive. According to the present example, memory portion 212 is identified. Specifically, the memory portion is identified by performing a search of data structure 217 based on an identifier of the given logical drive. As can be readily appreciated, the search yields an identifier of the memory portion that is mapped to the given logical drive.

At step 606, the identified memory portion is blocked. Blocking the memory portion may include any action that prevents data from being written to the memory portion and/or prevents data from being deleted from the memory portion. In one example, blocking the memory portion may include setting an access control bit that is associated with the memory portion to a value that indicates that the memory portion cannot be modified. In another example, blocking the memory portion may include: (i) identifying a plurality of access control bits, wherein each bit controls access to a different cache slice or block in the memory portion, and (ii) setting each of the identified bits to a value that indicates that the bit's corresponding cache slice or block cannot be modified.

At step 608, controller 140 sets the write policy of the given logical drive (i.e., logical drive 242) to write-through. Step 608 may be performed in the same manner as step 312 (shown in FIG. 3). Executing step 608 would cause the given logical drive (i.e., logical drive 242) to begin operating in WT mode when it comes back online and prevent any changes to the memory portion from being made until any relevant data that is stored in the memory portions (i.e., data associated with write requests) is copied to the given logical drive 242 (i.e., logical drive).

At step 610, controller 140 waits until the given logical drive is back online.

At step 612, controller 140 copies relevant data from the memory portion (identified at step 604) to one of the groups of physical storage devices that underlie the given logical drive. According to the present example, data associated with write requests that are pending in the memory portion (identified at step 604) is copied to the underlying group of physical storage devices. According to the present example, the data is copied to RAID group 142 (shown in FIGS. 1-2A).

At step 614, controller 140 unblocks the memory portion (identified at step 604). In one example, unblocking the memory portion may include setting an access control bit that is associated with the memory portion to a value that indicates that the memory portion is permitted to be modified. In another example, unblocking the memory portion may include: (i) identifying a plurality of access control bits, wherein each bit controls access to a different cache slice or block in the memory portion, and (ii) setting each of the identified bits to a value that indicates that the bit's corresponding cache slice or block is permitted to be modified.

At step 616, controller 140 changes the write policy of the given logical drive (i.e., logical drive 242) to write-back (WB) and begins operating the given logical drive in WB mode.

FIGS. 1-6 are provided as an example only. In some embodiments, the term “I/O request” or simply “I/O” may be used to refer to an input or output request. In some embodiments, an I/O request may refer to a data read or write request. At least some of the steps discussed with respect to FIGS. 1-6 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard. (1/23)

It will be further understood that various changes in the details, materials, and arrangements of the parts which have been described and illustrated in order to explain the nature of the claimed invention might be made by those skilled in the art without departing from the scope of the following claims.

1. A method, comprising:
identifying, by a processing circuitry of a storage device controller, a plurality of memory portions of a volatile memory of the storage device controller;
generating, by the processing circuitry, one or more data structures that map each of the plurality of memory portions to a different one of a plurality of logical drives;
using each of the plurality of memory portions to exclusively cache data for the one of the plurality of logical drives that is mapped to that memory portion, such that none of the memory portions is used to cache data for any of the plurality of logical drives other than the logical drive that is mapped to that memory portion;
detecting, by the processing circuitry, a failure of a given one of the plurality of logical drives;
identifying the one of the plurality of memory portions that is mapped to the given logical drive;
blocking the identified memory portion while allowing the remaining ones of the plurality of memory portions to be used for the caching of data, so as to permit the plurality of logical drives, other than the given logical drive, to operate in write-back mode while the given logical drive is unavailable;
causing the given logical drive to operate in write-through mode after the given logical drive comes back online, until write pending data that is stored in the identified memory portion is copied to the given logical drive; and
unblocking the identified memory portion and causing the given logical drive to operate in write-back mode after the write pending data is copied from the identified memory portion to the given logical drive.

2. (canceled)

3. The method of claim 1, wherein the volatile memory of the storage device controller includes dynamic random-access memory (DRAM) of the storage device controller.

4. The method of claim 1, wherein using any respective one of the plurality of memory portions to cache data for a respective one of the plurality of logical drives that is mapped to the respective memory portion includes:
obtaining data that is required to be written to the respective logical drive;
identifying a cache slot that is part of the respective memory portion, the cache slot being identified by using at least one of the data structures; and
storing the data in the identified cache slot.

5. The method of claim 1, wherein the one or more data structures include a data structure that maps each of a plurality of address ranges in the volatile memory of the storage device controller to a corresponding identifier of one of the plurality of logical drives.

6. The method of claim 1, wherein the one or more data structures include a hash map, the hash map being configured to identify a least recently used cache slot in at least one of the plurality of memory portions.

7. The method of claim 1, wherein each of the plurality of memory portions is configured to operate as a circular buffer.

8. The method of claim 1, wherein the storage device controller includes a Redundant Array of Independent Disks (RAID) controller.

9. A storage device controller, comprising:
a volatile memory; and
a processing circuitry that is operatively coupled to the volatile memory, the processing circuitry being configured to perform the operations of:
identifying a plurality of memory portions of the volatile memory;
generating one or more data structures that map each of the plurality of memory portions to a different one of a plurality of logical drives;
using each of the plurality of memory portions to exclusively cache data for the one of the plurality of logical drives that is mapped to that memory portion, such that none of the memory portions is used to cache data for any of the plurality of logical drives other than the logical drive that is mapped to that memory portion;
detecting, by the processing circuitry, a failure of a given one of the plurality of logical drives;
identifying the one of the plurality of memory portions that is mapped to the given logical drive;
blocking the identified memory portion while allowing the remaining ones of the plurality of memory portions to be used for the caching of data, so as to permit the plurality of logical drives, other than the given logical drive, to operate in write-back mode while the given logical drive is unavailable;
causing the given logical drive to operate in write-through mode after the given logical drive comes back online, until write pending data that is stored in the identified memory portion is copied to the given logical drive; and
unlocking the identified memory portion and causing the given logical drive to operate in write-back mode after the write pending data is copied from the identified memory portion to the given logical drive.

10. (canceled)

11. The storage device controller of claim 9, wherein the volatile memory of the storage device controller includes dynamic random-access memory (DRAM) of the storage device controller.

12. The storage device controller of claim 9, wherein using any respective one of the plurality of memory portions to cache data for a respective one of the plurality of logical drives that is mapped to the respective memory portion includes:
obtaining data that is required to be written to the respective logical drive;
identifying a cache slot that is part of the respective memory portion, the cache slot being identified by using at least one of the data structures; and
storing the data in the identified cache slot.

13. The storage device controller of claim 9, wherein the one or more data structures include a data structure that maps each of a plurality of address ranges in the volatile memory of the storage device controller to a corresponding identifier of one of the plurality of logical drives.

14. The storage device controller of claim 9, wherein the one or more data structures include a hash map, the hash map being configured to identify a least recently used cache slot in at least one of the plurality of memory portions.

15. The storage device controller of claim 9, wherein each of the plurality of memory portions is configured to operate as a circular buffer.

16. The storage device controller of claim 9, wherein the storage device controller includes a Redundant Array of Independent Disks (RAID) controller.

17. A non-transitory computer-readable storage medium storing one or more processor-executable instructions, which, when executed by a processing circuitry of a storage device controller, cause the processing circuitry to perform the operations of:
identifying, by a processing circuitry of a storage device controller, a plurality of memory portions of a volatile memory of the storage device controller;
generating, by the processing circuitry, one or more data structures that map each of the plurality of memory portions to a different one of a plurality of logical drives;
using each of the plurality of memory portions to exclusively cache data for the one of the plurality of logical drives that is mapped to that memory portion, such that none of the memory portions is used to cache data for any of the plurality of logical drives other than the logical drive that is mapped to that memory portion;
detecting, by the processing circuitry, a failure of a given one of the plurality of logical drives;
identifying the one of the plurality of memory portions that is mapped to the given logical drive; and
blocking the identified memory portion while allowing the remaining ones of the plurality of memory portions to be used for the caching of data, so as to permit the plurality of logical drives, other than the given logical drive, to operate in write-back mode while the given logical drive is unavailable;
causing the given logical drive to operate in write-through mode after the given logical drive comes back online, until write pending data that is stored in the identified memory portion is copied to the given logical drive; and
unlocking the identified memory portion and causing the given logical drive to operate in write-back mode after the write pending data is copied from the identified memory portion to the given logical drive.

18. (canceled)

19. The non-transitory computer-readable medium of claim 17, wherein the volatile memory of the storage device controller includes dynamic random-access memory (DRAM) of the storage device controller.

20. The non-transitory computer-readable medium of claim 17, wherein using any respective one of the plurality of memory portions to cache data for a respective one of the plurality of logical drives that is mapped to the respective memory portion includes:
obtaining data that is required to be written to the respective logical drive;
identifying a cache slot that is part of the respective memory portion, the cache slot being identified by using at least one of the data structures; and
storing the data in the identified cache slot.
